(19) United States
(12) Patent Application Publication
(10) Pub. No.: US 2024/0074624 A1
(43) Pub. Date: Mar. 7, 2024

(54) TOILET PAPER ROLL

(71) Applicant: Daio Paper Corporation, Ehime (JP)

(72) Inventor: Yoshimi AMANO, Shizuoka (JP)

(21) Appl. No.: 18/248,582

(22) PCT Filed: Oct. 12, 2021
(86) PCT No.: PCT/JP2021/037672

§ 371 Date: Apr. 11, 2023

(30) Foreign Application Priority Data
Oct. 14, 2020 (JP) 2020-173384

(51) Int. Cl. A47K 10/16; B41M 5/50; D21H 19/68; D21H 27/00; D21H 27/30

(52) U.S. Cl. CPC A47K 10/16; B41M 5/50; D21H 19/68; D21H 27/002; D21H 27/30

(57) ABSTRACT

Provided is a toilet paper roll of a longer product, having a pattern with excellent design visually observable, and little creases and crumples. The toilet paper roll is a roll of two-ply toilet paper with a roll diameter of 110 to 115 mm, the toilet paper having a paper thickness of 60 to 90 μm per ply, wherein the toilet paper has a pattern printed by halftone printing and solid printing on one of its surfaces, the total area of the pattern accounts for 10 to 20%, the total area of halftone printed areas accounts for 7.5% or more, and the total area of solid printed areas accounts for 4.0% or less, of a surface of the toilet paper, and 65 to 90 m of the toilet paper has been rolled around a paper tube at a roll density of 0.83 to 2.05, with the one of its surfaces bearing the pattern positioned externally.

### FIELD OF ART

The present invention relates to a toilet paper roll or toilet paper rolled into a roll.

### BACKGROUND ART

Toilet paper rolls are daily necessities that are spent on a daily basis, and a longer roll length is an important factors for consumers to decide on purchasing, as the bathroom space is limited.

The roll length of common toilet paper rolls for general household use has been generally about 25 m in 2 ply products, also referred to as double type products, and about 50 m in 1 ply products, also referred to as single type products. Recently, longer rolls are also spreading, which have a roll length 1.5 to 3 times the common products (Patent Publication 1).

Such longer toilet paper rolls are required, in order to achieve a roll diameter that is usable on general household toilet paper roll holders, to have a lower basis weight and a smaller paper thickness, and to have the paper rolled tighter.

Some conventional common 2-ply toilet paper rolls of about 25 m long and 1-ply toilet paper rolls of about 50 m long have patterns, such as of floral motifs, printed in ink on the toilet paper (Patent Publication 2). These toilet paper rolls are excellent in design.

### PRIOR ART PUBLICATION

### Patent Publication

Patent Publication 1: JP 2018-064664 A
Patent Publication 2: JP 2008-188070 A

### SUMMARY OF THE INVENTION

### Problems to be Solved by the Invention

With the longer toilet paper rolls, which are required to have a lower basis weight and a smaller paper thickness and to have the paper rolled tighter, printing of a pattern may result in the printing ink bleeding through to cause unnecessary ink bleed on the back side of the paper.

Further, the base paper with a smaller paper thickness to which ink is applied and which is rolled tighter, is prone to breakage as well as creases and crumples during production.

In addition, a toilet paper roll has layers of toilet paper arranged one on top of another, so that in a longer toilet paper roll, the pattern on the toilet paper of a lower layer may be observed excessively to impair the desired design of the pattern.

It is therefore an object of the present invention to provide a toilet paper roll of a longer product that is easy to manufacture, free of creases and crumples, and has a pattern with excellent design visually observable.

### Means for Solving the Problem

The first means for solving the above problem is a toilet paper roll including a paper tube, and two-ply toilet paper which has a paper thickness of 60 to 90 μm per ply and is rolled into a roll having a roll diameter of 110 to 115 mm, wherein the toilet paper has a pattern printed by halftone printing and solid printing on one of its surfaces, wherein a total area of the pattern accounts for 10 to 20%, a total area of halftone printed areas accounts for 7.5% or more, and a total area of solid printed areas accounts for 4.0% or less, of a surface of the toilet paper, and wherein 65 to 90 m of the toilet paper has been rolled around the paper tube at a roll density of 0.83 to 2.05, with the one of its surfaces bearing the pattern positioned externally.

The second means is the toilet paper roll according to the first means, wherein the toilet paper roll has a void fraction of 5 to 18%.

### Effect of the Invention

According to the present invention mentioned above, a toilet paper roll is provided that is easy to manufacture, free of creases and crumples, and has a pattern with excellent design visually observable, irrespective of its longer roll length.

### BRIEF DESCRIPTION OF THE DRAWINGS

FIG. 1 is a perspective view of a toilet paper roll according to an embodiment of the present invention.

FIG. 2 is a schematic view for explaining the procedure for measurement of brightness and color difference according to the present invention.

FIG. 3 is a graphic for explaining the printed patter according to the present invention.

### EMBODIMENTS FOR CARRYING OUT THE INVENTION

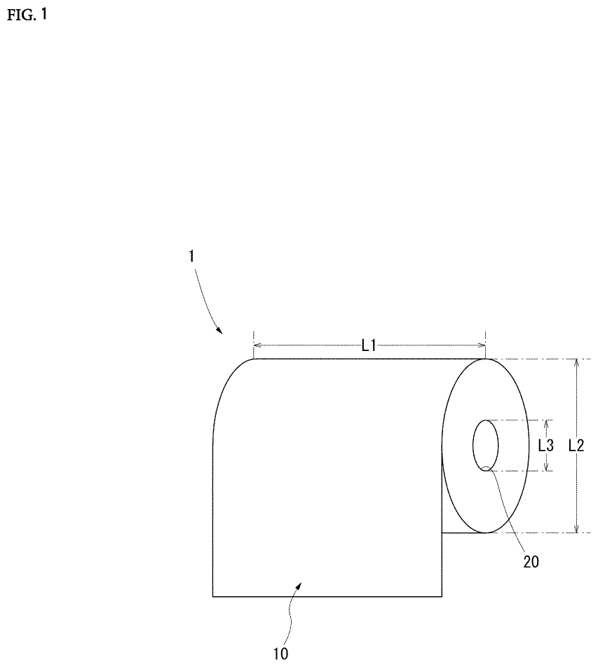

A toilet paper roll according to the present invention will now be explained with reference to the drawings. As shown in FIG. 1, a toilet paper roll 1 according to the present invention has a strip of 2-ply toilet paper 10 rolled around a paper tube (also referred to as paper core) 20.

The roll diameter L2 (diameter) of the toilet paper roll according to the present invention is 110 to 115 mm. The roll diameter of toilet paper rolls is provided in JIS P 4501 as being 120 mm or smaller, and roll holders on which common toilet paper rolls fit are produced on the basis of this dimension of 120 mm. The toilet paper roll according to the present invention has a roll diameter of 110 to 115 mm, which sufficiently fits on common roll holders. Here, the roll diameter refers to a value measured with DIAMETER RULE manufactured by MURATEC-KDS CORP. or an equivalent thereof. An average of values measured at three different locations shifted in the width direction is taken as the measured value.

In the toilet paper roll according to the present invention, characteristically, the toilet paper has a paper thickness of 60 to 90 μm per ply and has a pattern printed by halftone printing and solid printing on one of its surfaces, wherein the total area of the pattern accounts for 10 to 20%, the total area of halftone printed areas accounts for 7.5% or more, and the total area of solid printed areas accounts for 4.0% or less, of the toilet paper, and wherein 65 to 90 m of the toilet paper has been rolled around a paper tube at a roll density of 0.83 to 2.05, with the one of its surfaces bearing the pattern positioned externally.

In the toilet paper roll according to the present invention, which has such a construction, upon printing of a pattern, the printing ink is hard to bleed through to the back side of the paper, which hardly causes unnecessary ink bleed on the back side and paper breakage during production. Further, the toilet paper roll is free of creases and crumples on the paper, and has a characteristic design in which halftone printed areas and solid printed areas, and the pattern on the lower layer are not excessively observable.

In the toilet paper roll according to the present invention, the paper thickness of the rolled toilet paper is 60 to 90 μm per ply. With the paper thickness per ply within this range, sufficient strength and softness as toilet paper may be imparted and, when the toilet paper of 65 to 90 m long is rolled around a paper tube, the roll diameter L2 (diameter) may fall within the range of 110 to 115 mm. Further, under the conditions of printing pattern according to the present invention, the ink may be kept from bleeding through to the back side of the paper, unnecessary ink bleed on the back side may be avoided, and paper breakage during production may be hard to occur.

The paper thickness is determined by subjecting a test piece to moisture conditioning under the conditions provided in JIS P 8111 (1998) for 8 hours or longer, and then measuring the thickness in one ply under the same conditions using a dial thickness gauge (thickness measuring device) PEACOCK Model G (manufactured by OZAKI MFG. CO., LTD.). Specifically, the dial thickness gauge is checked for any dust, dirt, and the like between the plunger and the anvil, the plunger is lowered onto the anvil, and the scale is moved to adjust the zero point. Next, the plunger is raised, a specimen is placed on the anvil, and then the plunger is slowly lowered onto the specimen to read the scale. Upon measurement, the plunger is merely placed on the specimen and is not pressed against it. The terminal of the plunger is made of metal and has a flat circular surface of 10 mm in diameter, which is brought into contact with the paper plane perpendicularly. The load for this measurement of paper thickness is about 70 gf. The average of ten measured values is taken as the paper thickness. Note that, even the toilet paper to be measured has concaves and convexes formed by embossing, the same procedure is applied for the measurement. In this case, every concave is placed in its entirety within the area of the anvil for measurement. Collapse of concaves and convexes upon measurement may be ignored. In this measurement of paper thickness, the difference in paper thickness caused by collapsing of concaves is negligible.

The toilet paper according to the present invention has a basis weight of preferably 11.5 to 16.0 g/m², more preferably, 12.0 to 15.5 g/m². With the basis weight of 12.5 to 16.0 g/m², the toilet paper roll according to the present invention may easily be adjusted in its roll density and void fraction. Further, the toilet paper roll according to the present invention may suitably be adjusted in its dry tensile strength and wet tensile strength in commonly known manners, as long as the functions and effects of the present invention are not adversely affected.

In the toilet paper roll according to the present invention, the toilet paper has a pattern printed on one of its surfaces, and is rolled around a paper tube, with the surfaces bearing the pattern positioned externally. That is, the present toilet paper roll bears a pattern only on the outer surface. The pattern, which is printed on the external surface, may be observed directly from outside, in particular, even a pattern printed lightly by halftone printing may be observed clearly.

Further, as a toilet paper roll has layers of toilet paper arranged one on top of another, if the pattern on the toilet paper one or more layers below is seen through the top layer, the pattern on the top layer may be disadvantageously observed mingled with the pattern on the layers below. However, the toilet paper according to the present invention is, in particular, 2-ply, wherein the ply to be positioned internally in the roll provides a non-printed layer, so that, with the paper thickness falling within the range according to the present invention, and with only the outer layer bearing a pattern, the pattern on the top layer may sufficiently be observed, while the pattern on the layer below may hardly be observed. This is even more so with the basis weight mentioned above. Note that the toilet paper roll bearing a pattern only on the outer surface of the toilet paper may be produced by rolling up the toilet paper with the printed surface positioned externally.

The pattern according to the present invention is made by printing, and excludes a pattern colored by, e.g., supplying dyes to the raw materials in the papermaking stage. Specific design of the pattern is not particularly limited. For example, the pattern may include forms wherein one or more motifs are drawn, which are suitably selected from the group consisting of plants, such as flowers, trees, and herbs; living things, such as humans, animals, fish, shellfish, and insects; nature, such as mountains, rivers, seas, clouds, forests, and woods; planets and satellites, such as the moon, the sun, and stars; and artificial objects, such as vehicles, aircrafts, and trains. The area of one motif is not particularly limited, and may be about 102 mm² to 918 mm² for ready visibility, likely recognition of excellent design, and not an excess amount of ink for one motif, which hardly causes bleeding through of the ink.

The pattern according to the present invention is printed by halftone printing and solid printing. The proportion of the total area of the pattern is 10 to 20%. Here, the pattern is the combination of halftone printed areas and solid printed areas. The proportion of the total area means the proportion of the area of the pattern with respect to the area of one of the surfaces of the toilet paper. Note that the toilet paper bearing a pattern printed thereon has motifs repeated at predetermined intervals due to its production process. As such, the proportion of the total area of the pattern may be determined by cutting ten pieces of specimens each of 50 cm long out of the toilet paper from its free end except for the tail seal, calculating the proportion of the area of the pattern with respect to the area of one of the surfaces of each piece (the width of the toilet paper×50 cm), and taking the average of the ten pieces as the outcome. The area of the pattern in a specimen may be determined by optically scanning the specimen and performing calculation using a known software.

With a proportion of the total area of the pattern being 10 to 20%, the toilet paper does not provide, upon use, hard texture caused by the ink application, and in particular, generation of creases and crumples may be avoided during production at the tension of the toilet paper required for achieving the other roll constructions of the present invention, such as the roll length and the roll diameter. Note that the pattern printed by the halftone print is composed of, at the micro level, inked areas and non-inked areas but, according to the present invention, the halftone printed areas mean the overall areas actually perceived as a halftone printed pattern including not only the inked areas, but also the non-inked areas. The ratio of the halftone printed areas to the solid printed areas in a pattern is preferably 60:40 to 90:10, particularly preferably 65:35 to 85:15.

In the halftone printing according to the present invention, the shape of each halftone dot is not particularly limited and may be, for example, rhombus, square, rectangle, circle, ellipse, polygon, or a star shape.

Further, in the toilet paper according to the present invention, the proportion of the total area of the halftone printed areas is 7.5% or more, whereas the proportion of the total area of the solid printed areas is 4.0% or less. With the toilet paper having the proportion of the total area of the halftone printed areas being 7.5% or more, and the proportion of the total area of the solid printed areas being 4.0% or less, the applied ink hardly bleeds through the paper, while the perceivability of the pattern is not impaired, which results in excellent design. Further, the toilet paper as a whole does not provide excessively hard texture, and creases and crumples are hard to be generated during production. Moreover, in combination with other features of the present invention, the toilet paper, when made into a toilet paper roll, keeps the solid printed areas from being excessively perceived through the externally-positioned areas having no printed pattern of the toilet paper, and allows the design to be readily perceived as intended.

Note that the proportion of the total area of the halftone printed areas and the proportion of the total area of the solid printed areas may be determined, in the same way as for the proportion of the total area of the pattern, by cutting ten pieces of specimens each of 50 cm long out of a toilet paper from its free end except for the tail seal, calculating the proportion of the area of the pattern with respect to the area of one of the surfaces of each piece (the width of the toilet paper×50 cm), and taking the average of the ten pieces as the outcome. The areas of the halftone printed areas and the solid printed areas in a specimen may be determined by optically scanning the specimen and performing calculation using a known software.

According to the present invention, the halftone dot area percentage of the halftone printed areas is 20 to 60%, particularly preferably 30 to 50%. As used herein, the halftone dot area percentage refers to the percentage of the actually inked areas in the halftone printed areas. With a halftone dot area percentage of less than 20%, the sharpness of the pattern may be impaired, whereas with a halftone dot area percentage of over 60%, the halftone printed areas are more like the solid printed areas, so that the lightness in the pattern by the halftone printing may be lost and the design may be degraded, resulting in the pattern printed areas tending to provide hard texture. Further, when the ink is water-based, the moisture causes the paper to shrink, which tends to cause more creases and crumples of the paper at the proportion of the total area of the pattern according to the present invention.

The pattern on the toilet paper according to the present invention may preferably be printed by flexographic printing (relief printing) with water-based ink, but intaglio printing, such as gravure printing, or planographic printing, such as offset printing, may also be employed. With water-based ink having a viscosity of 10 to 50 cps and a water content of 95 to 75 mass % and containing 5 to 25 mass % vehicle, the pattern may be made sufficiently sharp, while creases and crumples are hard to be formed even when the water penetrates into the paper. Note that the viscosity is a value measured with a B-type viscometer.

For printing the pattern according to the present invention, irrespective of the halftone printing or the solid printing, the number of the lines of the anilox roller is preferably 40 to 100 lines per inch, more preferably 50 to 80 lines per inch. This is suitable for forming the pattern according to the present invention.

In the toilet paper roll according to the present invention, 65 to 90 m of the toilet paper having the pattern discussed above has been rolled around a paper tube at a roll density of 0.83 to 2.05. The roll length of 65 to 90 m is more than twice the roll length of a conventional 2-ply common product for general household use having a roll length of about 25 m. Note that the roll length is measured while the toilet paper is unrolled from the toilet paper roll without tension. For example, the measurement may be made while the paper is folded in a zigzag manner every 5 m from the unrolling end.

The toilet paper roll according to the present invention, which has the above-mentioned roll length, has a roll density of 0.83 to 2.05, preferably 1.05 to 1.45, more preferably 1.05 to 1.25. The roll density according to the present invention refers to a value calculated by multiplying the actual sectional area by the theoretical sectional area. The actual sectional area refers to a value calculated by multiplying the roll length by the paper thickness, whereas the theoretical sectional area refers to a value calculated by (roll diameter/2)× (roll diameter/2)×π−(outer diameter of paper tube/2)× (outer diameter of paper tube/2)×π. That is, the theoretical sectional area refers to an area obtained by subtracting the area of the open end of the paper tube from the area of the roll end face. With the roll length discussed above, a roll at a roll density of particularly 0.83 to 2.05 may easily be manufactured with few creases and crumples. Further, when the roll is held in hands on its circumferential surface, moderate tightness and sufficient roll length may be felt, and the roll is not excessively soft and is hard to provide a firm touch. At a roll density over 2.05, the roll may provide a firmer touch than it should do with the actual roll length. On the other hand, at a roll density below 0.83, the roll may provide an excessively softer touch than it should do with its roll length, which causes the tightness of the roll hard to be felt.

The toilet paper roll according to the present invention, wherein the total area of the pattern account for 10 to 20%, the total area of the halftone printed areas accounts for 7.5% or more, and the total area of the solid printed areas accounts for 4.0% or less, of the toilet paper, allows sufficient perception of the pattern, less bleeding through of the ink, and extremely few creases and crumples. In other words, when the roll length is to be made longer and the roll density is to be made higher, it is required to roll the toilet paper around a paper tube at a higher tension in forming a toilet paper roll. Toilet paper having a pattern printed thereon has different elongation between the inked, printed areas and the non-inked, non-printed areas, so that the toilet paper rolled into a toilet paper roll at a higher tension is prone to have creases and crumples formed thereon. However, these problems are solved by the toilet paper roll according to the present invention. That is, a toilet paper roll is provided, which, in particular, allows excellent perception of the pattern, little bleeding through of the ink and, when held in hands, provides a sufficiently soft touch as a product, without creases and crumples being formed. Note that the outer diameter of the paper tube (paper tube diameter) L3 is preferably 35 to 45 mmϕ, like the ordinary size. With the paper tube diameter within this range, the roll density of the toilet paper roll according to the present invention may be achieved.

Further, the toilet paper roll according to the present invention preferably has a void fraction of 5 to 18%. As used herein, the void fraction (%) refers to a value calculated by (actual void volume of the overall roll)/(theoretical roll volume)×100. The actual void volume of the overall roll is calculated by (actual sectional area (cm²))×(roll width (cm)), whereas the theoretical roll volume is calculated by (roll length (cm)×2×paper thickness (cm, per ply)×(roll width (cm)). The void fraction (actual void fraction over the roll, %) is calculated by ((theoretical roll volume (cm³))−(actual roll volume (cm³)))/(theoretical roll volume (cm³))×100(%). The roll width L1 may be about 100 to 130 mm. The void fraction according to the present invention is an index of how much space is present in a toilet paper roll. This index may be adjusted by adjusting embossing, paper thickness, and/or roll firmness. A larger paper thickness results in a lower void fraction, which is caused by excessively deep, hard, and hard-to-collapse embosses therein, or by a larger thickness of the paper layer per se. In either case, the roll may provide a firmer touch. The void fraction according to the present invention, when lower, imparts a firmer touch to the roll, and, when higher, imparts a softer touch to the roll. Note that, at a void fraction over 18%, the ink significantly bleeds through in the pattern area, which disturbs perception of the roll design, and the paper core may easily be displaced. At a void fraction below 5%, softness of the roll may be hard to be exhibited.

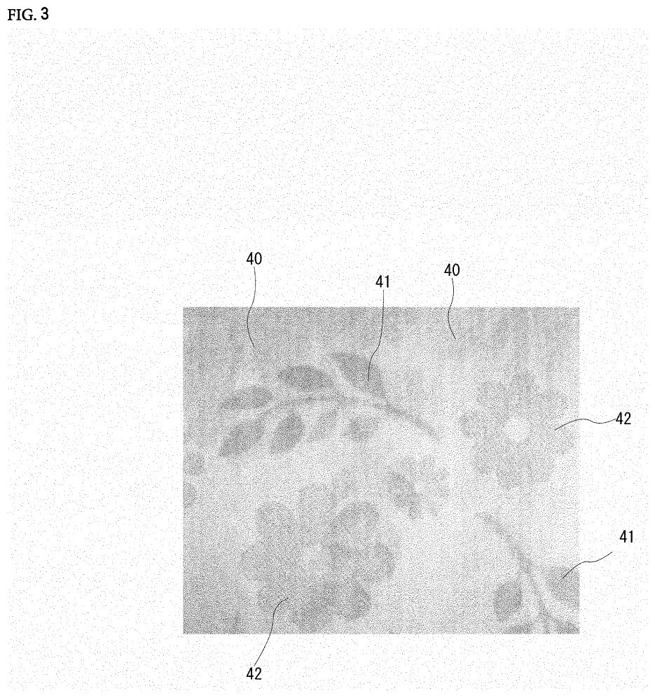

Further, it is preferred that the toilet paper according to the present invention has a brightness of 80% or higher in the areas having no printed pattern, and a color difference ΔE between the Lab value of the printed pattern on the lower layer directly measured and the Lab value of the same printed pattern measured through a white area having no printed pattern in the upper layer of the toilet paper, ΔE=((ΔL)²+(Δa)²+(Δb)²)^{1/2}, is 2.20 or less. Further, the color difference ΔE′ between the Lab value of the printed pattern measured through a white area having no printed pattern in the upper layer of the toilet paper and the Lab value of the white area having no printed pattern in the upper layer of the toilet paper is preferably 6.0 or less. With such brightness, ΔE, and ΔE′, as shown in FIG. 3, the pattern 40 on the lower layer of the toilet paper seen through the white area having no printed pattern in the upper layer is not observed excessively clearly, but observed lightly and blurredly. At the same time, the pattern composed of the solid printed areas 41 and the halftone printed areas 42, which is directly observed on the upper layer or the like, is clearly observed. In this way, the contrast between the pattern 41, 42 directly observed and the pattern 40 on the lower layer observed through the white area of the toilet paper produces unique, characteristic, design. In particular, with the area of the printed pattern accounting for 10 to 20%, the area of the pattern is not excessively large, and the contrast between the printed areas observable directly and the printed areas observable through the white areas and the upper layer produces favorable effect.

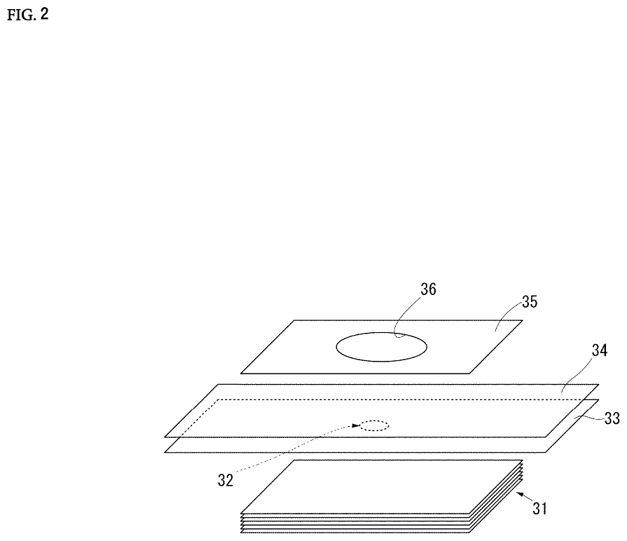

Here, the brightness and the color difference ΔE, ΔE′ according to the present invention may be determined as follows, as shown in FIG. 2. On a horizontal board for measurement, five sheets of white paperboard 31 are stacked one on another, and a specimen 33 to be subjected to the measurement is placed on top. A portion of the toilet paper 34 having no pattern printed thereon, taken out of the same toilet paper roll as the specimen 33 was taken out, is placed over the motif area 32 of the specimen 33, which is the object to be measured. A sheet of white paperboard 35 having a window opening 36 of 20 mm in diameter is placed on top so that the objective motif area 32 is positioned within the window opening 36.

Next, the brightness and the Lab value of the objective motif are measured through the window opening 36 and through the toilet paper 34 (Lab value of the printed pattern measured through the white area having no printed pattern in the upper layer of the toilet paper) by means of a spectroscopic brightness/color difference meter. Then, the toilet paper 34 placed on the specimen 32 is removed so as not to displace the measurement position, and the brightness and the Lab value of the objective motif area are measured (Lab value of the printed pattern on the lower layer measured directly) by means of the spectroscopic brightness/color difference meter. Further, the specimen is then removed, and the brightness and the Lab value of the topmost white paperboard 31 of the stack of five are measured (Lab value of the white area having no printed patterns in the upper layer of the toilet paper) by means of the spectroscopic brightness/color difference meter (blank value). Note that the spectroscopic brightness/color difference meter may be Spectrophotometric Whiteness & Color Meter PF 7000 manufactured by NIPPON DENSHOKU INDUSTRIES CO., LTD., or an equivalent thereof. The color difference ΔE, ΔE′ is calculated from the measured Lab values.

The number of colors constituting the pattern to be applied to the toilet paper according to the present invention is not limited, and may preferably be one to three colors in view of the cost, facilities, or the low density and vulnerability to bleeding of the toilet paper. Colors may be different between the solid printed areas and the halftone printed areas. Note that, in determining the Lab value of the pattern as discussed above, when one pattern includes a plurality of colors, the Lab value of each and every color is measured, and all of the obtained values preferably fall within the above-mentioned numerical range.

The fibers in the toilet paper according to the present invention are not limited, and may preferably be composed of 70 to 100 mass % virgin pulp and 0 to 30 mass % waste paper pulp. With the waste paper pulp blended, the toilet paper may be manufactured at a lower cost, compared to the cost of the toilet paper manufactured from 100 mass % virgin pulp. Further, the fibers of the waste paper pulp tend to be made finer in the course of recycling waste paper into pulp, compared to those before recycling. Due to such nature, the fibers tend to become dense to improve the paper strength without increasing the paper thickness. On the other hand, the fibers of the waste paper pulp, when added in an excessive amount, may impair texture, including softness. Thus, in view of the characteristics of the waste paper pulp, the proportion of the waste paper pulp may be decided within the range of 0 to 30 mass %. Note that the kind of waste paper pulp is not necessarily limited, and waste paper pulp derived from waste milk cartons or high-grade waste paper is particularly preferred. Such waste paper pulp contains a higher proportion of hardwood kraft pulp (LBKP) derived from the raw materials, which facilitates exhibition of paper strength.

The virgin pulp to be used is preferably softwood kraft pulp (NBKP) and hardwood kraft pulp (LBKP). The proportion NBKP:LBKP is preferably 20:80 to 50:50. Note that toilet paper produced from the fiber materials composed of such virgin pulp and the high-grade waste paper pulp mentioned above will contain 5 mass % or less mechanical pulp and 3 mass % or less ash, both derived from waste paper, and have a brightness of about 80 to 85%.

The toilet paper roll according to the present invention may have been embossed. When toilet paper is subjected to embossing, the toilet paper per se becomes soft and is given surface concaves and convexes, which enhance its ability to wipe off feces. Further, when toilet paper is subjected to embossing, concaves and convexes are formed on the paper surface, which makes the pattern on the lower layer hardly observable through the paper surface, and imparts excellent design.

Here, the toilet paper roll according to the present invention may have been embossed, but the embossed pattern is not necessarily limited. The embossing may be micro-embossing, dot-embossing, design embossing, or the like, to form any suitable embossed patterns. In this regard, however, the embossing according to the present invention is preferably double-embossing, which is formed by embossing each of two plies and overlaying one ply on the other. This facilitates achieving the roll density and the roll firmness according to the present invention.

### EXAMPLES

Next, Examples and Comparative Examples of the present invention were tested for their ability to keep printing ink from bleeding through. The construction of the toilet paper roll, and the properties and composition of the toilet paper in each example are shown in Table 1.

The ability to keep printing ink from bleeding through was evaluated as follows: toilet paper in which the ink bleeding through to the back side (non-printed side) was visually observed is evaluated as x, and toilet paper in which the ink was not visually observed is evaluated as ◯.

TABLE 1

| | | | | | | | Comp. | Comp. | Comp. | Comp. |
|---|---|---|---|---|---|---|---|---|---|---|
| | | Example | Example | Example | Example | Example | Example | Example | Example | Example |
| | | 1 | 2 | 3 | 4 | 5 | 1 | 2 | 3 | 4 |
| Basis weight | g/m³ | 13.6 | 14.3 | 15.2 | 15.9 | 12.5 | 13.7 | 14.5 | 15.4 | 16.0 |
| (per ply) | | | | | | | | | | |
| Paper thickness | μm | 65 | 65 | 74 | 75 | 70 | 69 | 88 | 80 | 87 |
| (per ply) | | | | | | | | | | |
| Roll length | m | 75 | 81 | 66 | 75 | 75 | 75 | 75 | 85 | 75 |
| (2 plies) | | | | | | | | | | |
| Roll diameter | φmm | 110 | 112 | 115 | 115 | 116 | 107 | 124 | 114 | 133 |
| Paper tube | φmm | 38 | 38 | 38 | 38 | 38 | 38 | 38 | 38 | 38 |
| diameter | | | | | | | | | | |
| Roll width | mm | 114 | 114 | 114 | 114 | 114 | 114 | 114 | 114 | 114 |
| Roll density | m/cm² | 1.16 | 1.21 | 1.06 | 1.22 | 1.11 | 1.32 | 1.21 | 1.50 | 1.02 |
| Theoretical | cm² | 97.5 | 105.3 | 97.7 | 112.5 | 105.0 | 103.5 | 132.0 | 136.0 | 130.5 |
| sectional area | | | | | | | | | | |
| (based on paper | | | | | | | | | | |
| thickness) | | | | | | | | | | |
| Theoretical roll | cm³ | 1111.5 | 1200.4 | 1113.6 | 1282.5 | 1197.0 | 1179.9 | 1504.8 | 1550.4 | 1487.7 |
| volume | | | | | | | | | | |
| Actual sectional | cm² | 83.7 | 87.2 | 92.5 | 92.5 | 94.3 | 78.6 | 109.4 | 90.7 | 127.6 |
| area (based on roll | | | | | | | | | | |
| dimensions) | | | | | | | | | | |
| Actual roll volume | cm³ | 954.1 | 993.8 | 1054.8 | 1054.8 | 1075.5 | 895.8 | 1247.4 | 1034.3 | 1454.5 |
| Actual void volume | cm³ | 157.4 | 206.6 | 58.7 | 227.7 | 121.5 | 284.1 | 257.4 | 516.1 | 33.2 |
| of overall roll | | | | | | | | | | |
| Void fraction | % | 14.2 | 17.2 | 5.3 | 17.8 | 10.2 | 24.1 | 17.1 | 33.3 | 2.2 |
| (actual void | | | | | | | | | | |
| fraction over roll) | | | | | | | | | | |
| Number of | | 2 | 2 | 3 | 2 | 2 | 2 | 3 | 2 | 2 |
| colors | | | | | | | | | | |
| Printing | | Flexo | Flexo | Flexo | Flexo | Flexo | Flexo | Flexo | Flexo | Flexo |
| method | | | | | | | | | | |
| Printing plate | | Solid + | Solid + | Solid + | Solid + | Solid + | Solid | Solid + | Solid | Solid |
| | | Halftone | Halftone | Halftone | Halftone | Halftone | | Halftone | | |
| Number of | lines/inch | 55 | 55 | 55 | 55 | 55 | 55 | 55 | 55 | 55 |
| lines of anilox | | | | | | | | | | |
| roller | | | | | | | | | | |
| Proportion of | % | 3.8 | 2.4 | 2.4 | 2.3 | 3.8 | 11.9 | 7.3 | 12.8 | 18.0 |
| total area of | | | | | | | | | | |
| solid printed | | | | | | | | | | |
| areas (A) | | | | | | | | | | |
| Proportion of | % | 8.1 | 10.4 | 11.6 | 16.3 | 8.1 | — | 10.6 | — | — |
| total area of | | | | | | | | | | |
| halftone | | | | | | | | | | |
| printed areas | | | | | | | | | | |
| (B) | | | | | | | | | | |
| Halftone dot | % | 40.0 | 40.0 | 40.0 | 40.0 | 40.0 | — | 40.0 | — | — |
| area | | | | | | | | | | |
| percentage | | | | | | | | | | |
| Proportion of | % | 11.9 | 12.8 | 14.0 | 18.6 | 11.9 | 11.9 | 17.9 | 12.8 | 18.0 |
| total area of | | | | | | | | | | |
| pattern | | | | | | | | | | |
| (A) + (B) | | | | | | | | | | |
| Proportion of | % | 68.1 | 81.3 | 82.9 | 87.6 | 68.1 | 0 | 59.2 | 0 | 0 |
| halftone | | | | | | | | | | |
| printed areas | | | | | | | | | | |
| Proportion of | % | 31.9 | 18.8 | 17.1 | 12.4 | 31.9 | 100 | 40.8 | 100 | 100 |
| solid printed | | | | | | | | | | |
| areas | | | | | | | | | | |
| Proportion of | % | 7.0 | 6.6 | 7.0 | 8.8 | 7.0 | 11.9 | 11.5 | 12.8 | 18.0 |
| total area of | | | | | | | | | | |
| inked areas | | | | | | | | | | |
| Color | — | 1.95 | 1.89 | 1.91 | 2.17 | 1.94 | 2.29 | 2.33 | 2.23 | 2.61 |
| difference ΔE | | | | | | | | | | |
| Ability to keep | 1-5 | 5 | 5 | 5 | 4 | 5 | 2 | 3 | 2 | 1 |
| ink from | by visual | | | | | | | | | |
| bleeding | observation | | | | | | | | | |
| through | | | | | | | | | | |

In Examples 1 to 4, the toilet papers had smaller paper thicknesses for making the roll longer, but had sufficient design by halftone printing, with the total area of the pattern accounting for 10% or more, while the toilet papers keep the ink from bleeding through. In contrast, in Comparative Example 1, the entire pattern was solid printed, while the proportion of the total area of the pattern is the same as in Example 1. In this Comparative Example 1, bleeding through of the ink was observed.

In Comparative Example 2, the pattern was composed of halftone printed areas and solid printed areas, with the proportion of the total area of the solid printed areas being higher than that according to the present invention. In this Comparative Example 2, bleeding through of the ink was observed.

In Comparative Examples 3 and 4, the pattern was composed solely of solid printed areas, while the proportions of the total area of the pattern were the same as those in Examples 2 and 4, respectively. In these Comparative Examples, bleeding through of the ink was observed.

It was confirmed that the toilet paper roll according to the present invention kept the ink of the pattern from bleeding through even if the roll is of a longer type.

### DESCRIPTION OF REFERENCE NUMERALS

1: toilet paper roll
10: toilet paper
20: paper tube (paper core)
L1: roll diameter (diameter) of toilet paper roll
L2: diameter of paper tube of toilet paper roll
L3: width of toilet paper roll
31, 32: concave
33: valley line
40: pattern on lower layer
41: solid printed area in upper layer
42: halftone printed area in upper layer

1. A toilet paper roll comprising:
a paper tube, and
two-ply toilet paper which has a paper thickness of 60 to 90 μm per ply and is rolled around the paper tube into a roll having a roll diameter of 110 to 115 mm,
wherein the toilet paper has a pattern printed by halftone printing and solid printing on one of its surfaces,
wherein a total area of the pattern accounts for 10 to 20%, a total area of halftone printed areas accounts for 7.5% or more, and a total area of solid printed areas accounts for 4.0% or less, of a surface of the toilet paper, and
wherein 65 to 90 m of the toilet paper has been rolled around the paper tube at a roll density of 0.83 to 2.05, with the one of its surfaces bearing the pattern positioned externally.

2. The toilet paper roll according to claim 1, wherein the toilet paper roll has a void fraction of 5 to 18%.
